(19) United States
(12) Patent Application Publication
(10) Pub. No.: US 2013/0162748 A1
(43) Pub. Date: Jun. 27, 2013

(54) INTEGRATED IMAGING SYSTEM FOR PRINTING SYSTEMS

(71) Applicants: Mark C. Rzadca, Fairport, NY (US); Samuel Chen, Penfield, NY (US)

(72) Inventors: Mark C. Rzadca, Fairport, NY (US); Samuel Chen, Penfield, NY (US)

(21) Appl. No.: 13/332,415

(22) Filed: Dec. 21, 2011

(51) Int. Cl. B41J 2/47

(52) U.S. Cl. 347/258

(57) ABSTRACT

An integrated imaging system for a printing system that prints content on a moving print media includes a housing, an opening in the housing for receiving light reflected from the print media, a folded optical assembly in the housing that receives the reflected light and transmits the light a predetermined distance, and an image sensor within the housing that receives the light and captures one or more images of the printed content.

### CROSS-REFERENCE TO RELATED APPLICATION

This patent application is related to U.S. patent application Ser. No. ______ (Docket K000799), entitled “METHOD FOR DETECTING ARTIFACTS IN PRINTED CONTENT” filed concurrently herewith.

### TECHNICAL FIELD

The present invention generally relates to printing systems and more particularly to an integrated imaging system for printing systems.

### BACKGROUND

In commercial inkjet printing systems, a print media is physically transported through the printing system at a high rate of speed. For example, the print media can travel 650 feet per minute. The printheads in commercial inkjet printing systems typically include multiple nozzle plates, with each nozzle plate having precisely spaced and sized nozzles. The cross-track pitch, measured as drops per inch or dpi, is determined by the nozzle spacing. The dpi can be as high as 600, 900, or 1200 dpi. Due to the speed of the moving print media and the high dpi, a reliable system or method is desired for jetting the ink onto the moving print media, for maintaining the alignment of the moving print media with respect to the printheads, and for detecting defects or artifacts in the content printed on the moving print media.

Generally, the streams of drops emitted by each nozzle plate are parallel to each other in order to produce a uniform density on the moving print media. Failures in drop deposition can produce artifacts that extend in one direction, the media transport direction. For example, a blank streak is created when a nozzle stops ejecting ink drops. The blank streak lasts until ink is again ejected from the nozzle.

On the other hand, a “stuck on” jet will produce a dark line for the duration of the “stuck on” event. And the drops ejected from a crooked jet frequently intersect with one or more of the neighboring streams to produce a darker streak where the conjoined streams land on the print media and an adjacent lighter streak (or streaks) where the deviated streams are missing from the intended region of the print media.

These artifacts continue until the problem is corrected. Unfortunately, the necessary corrections may not occur for hundreds or thousands of feet of print media, which results in waste when the printed content is not usable. Additionally, wasted print media causes the print job to be more costly and time consuming.

There are two issues surrounding current artifact or defect detection systems, size and purpose. Current artifact detection systems use cameras configured to image the printed content in a fashion that represents, or substantially represents, a two-dimensional high resolution scene of the printed content. In order to create a two-dimensional high resolution representation of the printed content, the integration period of the camera is kept relatively short to avoid the blurring associated with longer integration times. Short integration times can be achieved by using a very intense illumination for short bursts that are synchronized with camera integration periods (frequently referred to as strobe illumination), by using a camera with high sensitivity and with short integration periods, or combinations thereof.

One conventional configuration for such cameras is to attach an imaging lens to the camera and then mount the camera to the structure at the distance appropriate to produce a focused image of the print media. The physical configuration of the separate components in the imaging system can consume a large volume of space within or around the printing system. Additionally, it can be difficult to shield the components of the imaging system from the environment created in or around the printing system. Elevated humidity, temperature and a dusty atmosphere can adversely impact the performance of one or more components in the imaging system.

Additionally, two-dimensional high resolution imaging of printed content on high speed printers typically requires higher performance cameras and light sources. High resolution imaging can also require the transmission of large amounts of data from the imaging system to a processing device. Due to the amount of data, the processing device requires increasing processing power and time, as well as potentially more complex analysis algorithms, to analyze the data. All of the factors can increase the cost to manufacture and the cost to operate an artifact detection imaging system.

As noted earlier, the other issue with current artifact detection systems is the purpose or product produced by the imaging system. Most commercially available imaging systems are designed to detect discrete artifacts in the printed content, such as impurities or non-uniformities that differ from a nominally uniform background. These non-conforming artifacts can range in size from microns to millimeters. The non-conforming artifacts are randomly dispersed within an otherwise uniform background, which can be wide and moving at a high speed. An example may be a speck of dirt or a strand of hair inadvertently trapped on a paper surface during the manufacturing of a wide roll of paper, and the imaging system is designed to detect these features on a continuous basis. Because these artifacts can be small, the resolution of the camera sensor needs to be sufficiently high to resolve features at the micron level. For example, a 600 dpi resolution imaging sensor can resolve approximately 40 microns, while a 1200 dpi sensor can resolve approximately 20 microns. Higher resolution sensors are usually costlier than lower resolution sensors.

Furthermore, commercially available imaging systems are purposefully designed to avoid blur in the captured image so that the image processing of the captured images can use algorithms to accurately determine the nature of these artifacts. To achieve high resolution, non-blurred images, the imaging systems use high pixel density, two-dimensional (2D) area array sensors capable of a high refresh rate so that large areas of the moving print media can be captured sequentially and continuously. The captured images are then processed to determine the small and randomly occurring artifacts. The larger the digital data set (from the higher resolution sensors or cameras) the more costly the image processing hardware.

High refresh rate systems may also need to use special lighting capable of providing uniform and bright strobe lighting. in order to image large areas across a wide moving print media, captured images from several two-dimensional sensors need to be stitched together or relatively large two-dimensional sensors are required. Given the nominal capability of such high performance imaging systems to meet the needs of the printing industry and the heretofore small number of inkjet printers installed in the industry, there has been little demand for commercial vendors to develop separate imaging systems that can detect printing artifacts that are characteristic of ink jet based printing systems. The cost of printing systems places an exaggerated constraint on the number of imaging systems that can be used with an ink jet printing system, since several such imaging systems may be necessary or beneficial to ensure print quality.

### SUMMARY

In one aspect, an integrated imaging system for a printing system that prints content on a moving print media includes a housing, an opening in the housing for receiving light reflected from the print media, a folded optical assembly in the housing that receives the reflected light and transmits the light a predetermined distance, and an image sensor within the housing that receives the light and captures one or more images of the printed content on the moving print media.

In another aspect, an integrated imaging system can include vent openings in the housing. One vent opening can be used to input air or gas and another vent opening can be used to output exhaust. The integrated imaging system can further include a light source for emitting light towards the print media.

In another aspect, a printing system that includes one or more integrated imaging systems can include at least one motion encoder that transmits an electronic pulse or signal proportional to a fixed amount of incremental motion of the print media. A signal output by the motion encoder can be used to trigger one or more respective image sensors to begin integrating the light reflected from the print media.

In another aspect, a printing system that includes one or more integrated imaging systems can include at least one processing device that processes images captured by the integrated imaging system or systems.

In another aspect, a method for detecting artifacts in content printed on a moving print media includes capturing one or more images of the content as the print media is moving to obtain pixel data and averaging the pixel data to produce blur in one direction. The one direction can be the direction the print media is moving. Derivative data of the averaged pixel data is determined. A determination is then made as to whether or not one or more peaks are present in the derivative data. If one or more peaks are present, a determination can be made as to whether or not the one or more peaks meet or exceed a threshold value.

### BRIEF DESCRIPTION OF THE DRAWINGS

Embodiments of the invention are better understood with reference to the following drawings. The elements of the drawings are not necessarily to scale relative to each other.

FIG. 1 illustrates one example of an inkjet printing system for continuous web printing on a print media;

FIG. 2 depicts a portion of printing system 100 in more detail;

FIG. 3 illustrates a side of the support structure 204 that is adjacent to the print media 112 in an embodiment in accordance with the invention;

FIGS. 4-6 are graphical illustrations of possible streams of ink drops and expanded views of the possible streams in an embodiment in accordance with the invention;

FIG. 7 depicts a portion of a printing system in an embodiment in accordance with the invention;

FIG. 8 is a cross-sectional view along line 8-8 in FIG. 7 in an embodiment in accordance with the invention;

FIG. 9 is a cross-sectional view along line 9-9 in FIG. 7 in an embodiment in accordance with the invention;

FIG. 10 is a flowchart of a method for detecting artifacts in printed content on a moving print media in an embodiment in accordance with the invention;

FIG. 11 is an example plots of averaged pixel data and plots of derivative data for the streams of ink drops shown in FIGS. 4-6 in an embodiment in accordance with the invention; and

FIG. 12 illustrates a portion of a printed content that includes two artifacts and examples of average and derivative data in an embodiment in accordance with the invention.

### DETAILED DESCRIPTION

Throughout the specification and claims, the following terms take the meanings explicitly associated herein, unless the context clearly dictates otherwise. The meaning of “a,” “an,” and “the” includes plural reference, the meaning of “in” includes “in” and “on.”Additionally, directional terms such as “on”, “over”, “top”, “bottom”, “left”, “right” are used with reference to the orientation of the Figure(s) being described. Because components of embodiments of the present invention can be positioned in a number of different orientations, the directional terminology is used for purposes of illustration only and is in no way limiting.

The present description will be directed in particular to elements forming part of, or cooperating more directly with, an apparatus in accordance with the present invention. It is to be understood that elements not specifically shown, labeled, or described can take various forms well known to those skilled in the art. In the following description and drawings, identical reference numerals have been used, where possible, to designate identical elements. It is to be understood that elements and components can be referred to in singular or plural form, as appropriate, without limiting the scope of the invention.

The example embodiments of the present invention are illustrated schematically and not to scale for the sake of clarity. One of ordinary skill in the art will be able to readily determine the specific size and interconnections of the elements of the example embodiments of the present invention.

As described herein, the example embodiments of the present invention provide a printhead or printhead components typically used in inkjet printing systems. However, many other applications are emerging which use inkjet printheads to emit liquids (other than inks) that need to be finely metered and deposited with high spatial precision. Such liquids include inks, both water based and solvent based, that include one or more dyes or pigments. These liquids also include various substrate coatings and treatments, various medicinal materials, and functional materials useful for forming, for example, various circuitry components or structural components. As such, as described herein, the terms “liquid” and “ink” refer to any material that is ejected by the printhead or printhead components described below.

Inkjet printing is commonly used for printing on paper. However, there are numerous other materials in which inkjet is appropriate. For example, vinyl sheets, plastic sheets, textiles, paperboard, and corrugated cardboard can comprise the print media. Additionally, although the term inkjet is often used to describe the printing process, the term jetting is also appropriate wherever ink or other liquids is applied in a consistent, metered fashion, particularly if the desired result is a thin layer or coating.

Inkjet printing is a non-contact application of an ink to a print media. Typically, one of two types of ink jetting mechanisms are used and are categorized by technology as either drop on demand ink jet (DOD) or continuous ink jet (CIJ). The first technology, “drop-on-demand” (DOD) ink jet printing, provides ink drops that impact upon a recording surface using a pressurization actuator, for example, a thermal, piezoelectric, or electrostatic actuator. One commonly practiced drop-on-demand technology uses thermal actuation to eject ink drops from a nozzle. A heater, located at or near the nozzle, heats the ink sufficiently to boil, forming a vapor bubble that creates enough internal pressure to eject an ink drop. This form of inkjet is commonly termed “thermal ink jet (TIJ).”

The second technology commonly referred to as “continuous” ink jet (CU) printing, uses a pressurized ink source to produce a continuous liquid jet stream of ink by forcing ink, under pressure, through a nozzle. The stream of ink is perturbed using a drop forming mechanism such that the liquid jet breaks up into drops of ink in a predictable manner. One continuous printing technology uses thermal stimulation of the liquid jet with a heater to form drops that eventually become print drops and non-print drops. Printing occurs by selectively deflecting one of the print drops and the non-print drops and catching the non-print drops. Various approaches for selectively deflecting drops have been developed including electrostatic deflection, air deflection, and thermal deflection.

Additionally, there are typically two types of print media used with inkjet printing systems. The first type is commonly referred to as a continuous web while the second type is commonly referred to as a cut sheet(s). The continuous web of print media refers to a continuous strip of media, generally originating from a source roll. The continuous web of print media is moved relative to the inkjet printing system components via a web transport system, which typically include drive rollers, web guide rollers, and web tension sensors. Cut sheets refer to individual sheets of print media that are moved relative to the inkjet printing system components via rollers and drive wheels or via a conveyor belt system that is routed through the inkjet printing system.

The invention described herein is applicable to both types of printing technologies. As such, the term printhead, as used herein, is intended to be generic and not specific to either technology. Additionally, the invention described herein is applicable to both types of print media. As such, the term print media, as used herein, is intended to be generic and not as specific to either type of print media or the way in which the print media is moved through the printing system.

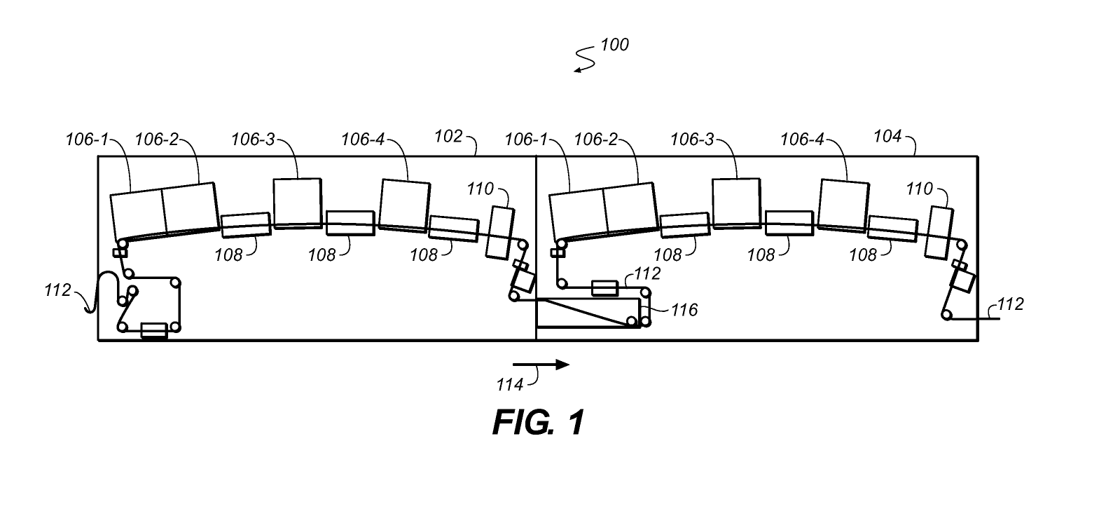

The terms “upstream” and “downstream” are terms of art referring to relative positions along the transport path of the print media; points on the transport path move from upstream to downstream. In FIGS. 1, 2 and 3, the media moves from left to right as indicated by transport direction arrow 114. Where they are used, terms such as “first”, “second”, and so on, do not necessarily denote any ordinal or priority relation, but are simply used to more clearly distinguish one element from another.

Referring now to the schematic side view of FIG. 1, there is shown one example of an inkjet printing system for continuous web printing on a print media. Printing system 100 includes a first printing module 102 and a second printing module 104, each of which includes lineheads 106, dryers 108, and a quality control sensor 110. Each linehead 106 typically includes multiple printheads (not shown) that apply ink or another liquid to the surface of the print media 112 that is adjacent to the printheads. For descriptive purposes only, the lineheads 106 are labeled a first linehead 106-1, a second linehead 106-2, a third linehead 106-3, and a fourth linehead 106-4. In the illustrated embodiment, each linehead 106-1, 106-2, 106-3, 106-4 applies a different colored ink to the surface of the print media 112 that is adjacent to the lineheads. By way of example only, linehead 106-1 applies cyan colored ink, linehead 106-2 magenta colored ink, linehead 106-3 yellow colored ink, and linehead 106-4 black colored ink.

The first printing module 102 and the second printing module 104 also include a web tension system that serves to physically move the print media 112 through the printing system 100 in the transport direction 114 (left to right as shown in the figure). The print media 112 enters the first printing module 102 from a source roll (not shown) and the linehead(s) 106 of the first module applies ink to one side of the print media 112. As the print media 112 feeds into the second printing module 104, a turnover module 116 is adapted to invert or turn over the print media 112 so that the linehead(s) 106 of the second printing module 104 can apply ink to the other side of the print media 112. The print media 112 then exits the second printing module 104 and is collected by a print media receiving unit (not shown).

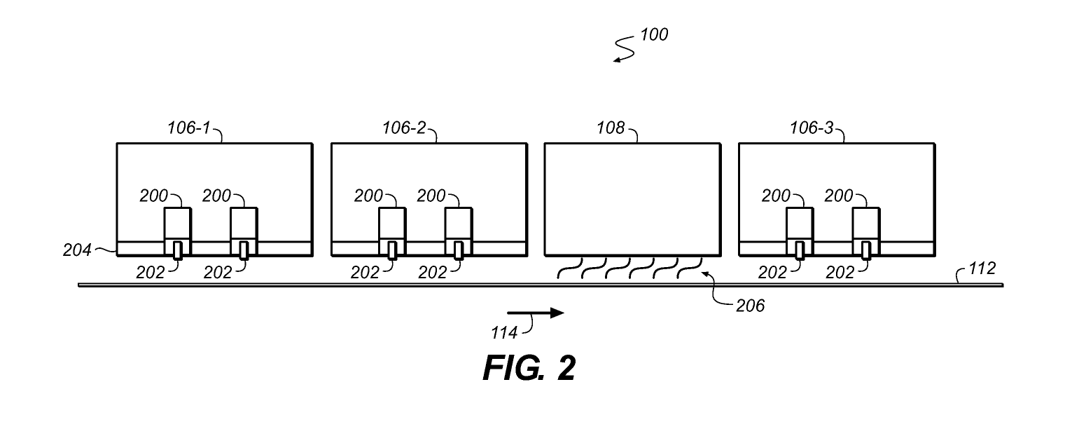

FIG. 2 illustrates a portion of printing system 100 in more detail. As the print media 112 is directed through printing system 100, the lineheads 106, which typically include a plurality of printheads 200, apply ink or another liquid onto the print media 112 via the nozzle arrays 202 of the printheads 200. The printheads 200 within each linehead 106 are located and aligned by a support structure 204 in the illustrated embodiment. After the ink is jetted onto the print media 112, the print media 112 passes beneath the one or more dryers 108 which apply heat 206 to the ink on the print media.

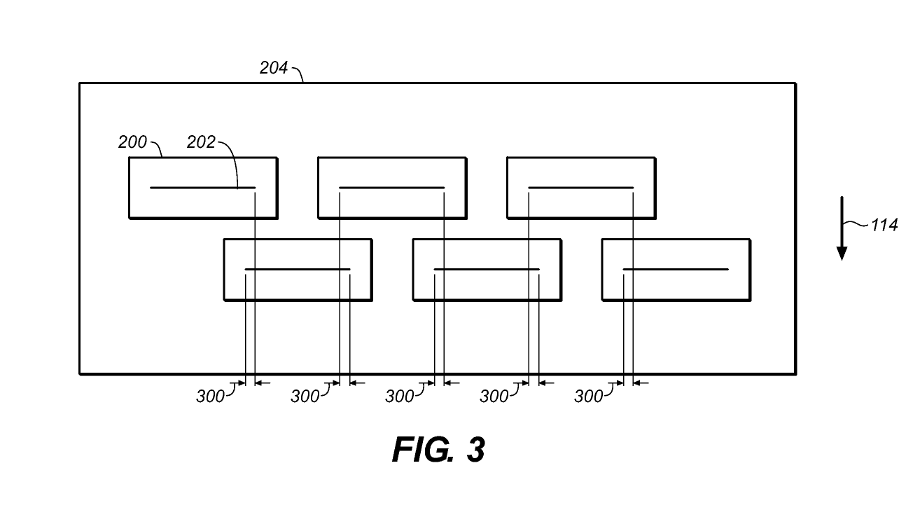

Referring now to FIG. 3, there is shown a side of the support structure 204 that is adjacent to the print media 112 in an embodiment in accordance with the invention. The printheads 200 are aligned in a staggered formation, with upstream and downstream printheads 200, such that the nozzle arrays 202 produce overlap regions 300. The overlap regions 300 enable the print from overlapped printheads 200 to be stitched together without a visible seam through the use of appropriate stitching algorithms that are known in the art. These stitching algorithms ensure that the amount of ink printed in the overlap region 200 is not higher than other portions of the print.

In a commercial ink jet printing system, such as the printing system depicted in FIG. 1, the printheads 200 are typically 4.25 inches wide and multiple printheads 200 are used to cover the varying widths of different types of print media. For example, the widths of the print media can range from 4.25 inches to 52 inches.

Each nozzle array 202 includes one or more lines of openings or nozzles that emit ink drops. The ink drops have a particular pitch or spacing in the cross-web direction. The cross-web pitch is determined by the spacing between nozzles. For example, cross-web ink drop pitches can vary from 300 to 1200 drops per inch.

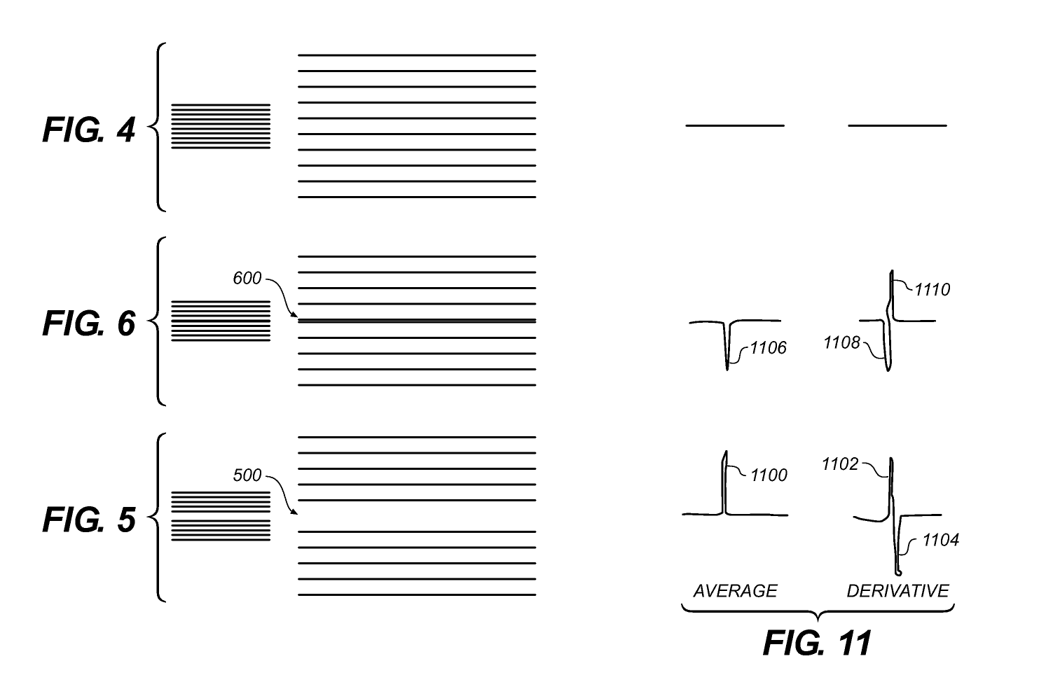

Streams of print drops can travel a distance of about 1 to 15 mm from the printhead to the print media in some printing systems. FIG. 4 illustrates a desired pattern of ink drops and an expanded view of the desired pattern. The streams of ink drops are illustrated as lines for simplicity. As shown in FIG. 4, the streams of drops are parallel to each other at the proper pitch. This produces a uniform density on the print media. Streams which are not parallel result in variations in density that are seen as adjacent light and dark band regions. Although there are a number of different failure modes for inkjet printing systems, several of the most common failures produce artifacts that extend in the media transport direction (e.g., direction 114 in FIG. 1). In the case where a nozzle stops ejecting ink drops (see FIG. 5), a blank streak 500 is created that continues until ink is again ejected from the nozzle.

A “stuck on” nozzle will produce a dark line for the duration of the “stuck on” event (see FIG. 6). Finally, the ink ejected from a crooked nozzle can intersect with ink stream from one or more neighboring nozzles and produce a darker streak 600 where the conjoined streams land on the print media and an adjacent lighter streak (or streaks) where the deviated streams are missing from the intended region of the print media. These described print defects (lighted and darker streaks) continue until the problem is corrected, and corrections may not occur for hundreds or thousands of feet of print media.

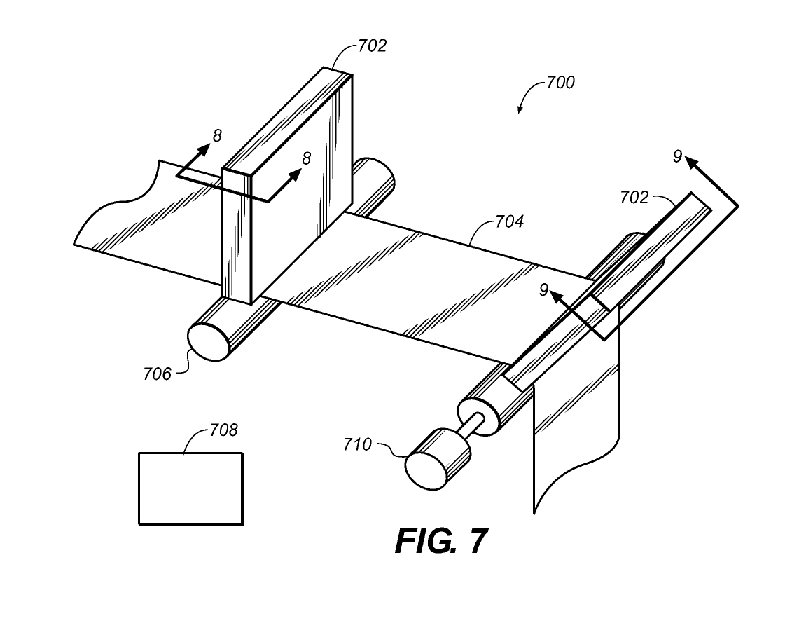

Referring now to FIG. 7, there is shown a portion of a printing system in an embodiment in accordance with the invention. Printing system 700 includes one or more integrated imaging systems 702 disposed over the print media 704. The integrated imaging systems 702 are connected to an image processing device 708 which is used to process and detect artifacts in the printed images on the print media 704. The artifacts include, but are not limited to, artifacts that are produced by missing nozzles, stuck on nozzles, crooked nozzles, and non-ink ejecting nozzles. The integrated imaging system 702 can be connected to and transmit pixel data to the image processing device 708 through any known wired or wireless connection.

The integrated imaging systems 702 are disposed over the print media 704 at locations in a printing system where the print media is transported over rollers 706 in an embodiment in accordance with the invention. The print media can be more stable, both in the cross-track and in-track (feed) directions, when moving over the rollers 706. In other embodiments in accordance with the invention, one or more integrated imaging systems can be positioned at any location in a printing system. By way of example only, in the printing system shown in FIG. 1, an integrated imaging system 704 can be located immediately after quality control sensors 110 in each printing module 102, 104.

Processing device 708 can be used to process the images captured by one or more integrated imaging systems 702. Processing device is implemented as a computer in an embodiment in accordance with the invention. Processing device 708 communicates with one or more integrated imaging systems 702 through any known wireless or wired connection.

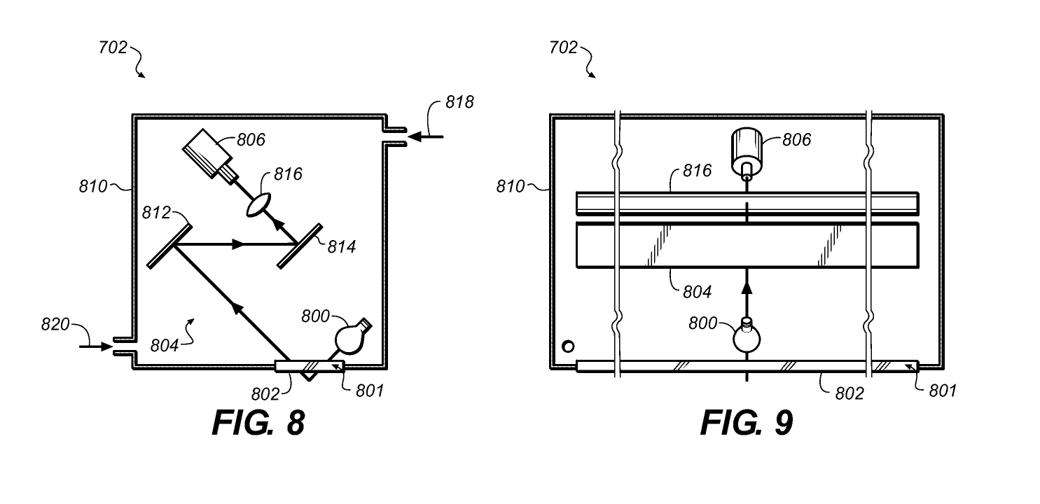

Motion encoder 710 can be used to produce an electronic pulse or signal proportional to a fixed amount of incremental motion of the print media in the feed direction. The signal from motion encoder 710 is used to trigger an image sensor (see 806 in FIG. 8) to begin capturing an image of the printed content on the moving print media using the light reflected off the print media.

FIG. 8 is a cross-sectional view along line 8-8 in FIG. 7 in an embodiment in accordance with the invention. Integrated imaging system 702 includes light source 800, transparent cover 802, folded optical assembly 804, and image sensor 806 all enclosed within housing 810. In the illustrated embodiment, folded optical assembly 804 includes mirrors 812, 814 and lens 816. Mirrors 812, 814 can be implemented with any type of optical elements that reflects light in embodiments in accordance with the invention.

Light source 800 transmits light through transparent cover 802 and towards the surface of the print media (not shown). The light reflects off the surface of the print media and propagates through the transparent cover 802 and along the folded optical assembly 804, where mirror 812 directs the light towards mirror 814, and mirror 814 directs the light toward lens 816. The light is focused by lens 816 to form an image on image sensor 806. Image sensor 806 captures one or more images of the print media as the print media moves through the printing system by converting the reflected light into electrical signals.

Folded optical assembly 804 bends or directs the light as it is transmitted to image sensor 806 such that the optical path traveled by the light is longer than the size of integrated imaging system 702. Folded optical assembly 804 allows the imaging system 702 to be constructed more compactly, reducing the weight, dimensions, and cost of the imaging system. Folded optical assembly 804 can be constructed differently in other embodiments in accordance with the invention. Additional or different optical elements can be included in folded optical assembly 804.

As discussed earlier, image sensor 806 can receive a signal from a motion encoder (e.g., 710 in FIG. 7) each time an incremental motion of the print media occurs in the feed direction. The signal from the motion encoder is used to trigger image sensor 806 to begin integrating the light reflected from the print media. In the case of a linear image sensor, the unit of incremental motion is typically configured such that an integration period begins with sufficient frequency to sample or image the print media in the feed direction with the same resolution as is produced in the cross-track direction. If the trigger occurs at a rate which produces a rate that results in sampling in the in-track (feed) direction at a higher rate, an image that is over sampled in that direction is produced and the imaged content appears elongated or stretched in the in-track direction. Conversely, a rate that is lower for the in-track direction produces imaged content that is compressed in the in-track direction.

The time period over which the integration occurs determines how much print media moves through the field of view of the imaging system. With shorter integration periods such as a millisecond or less, the motion of the print media can be minimized so that fine details in the in-track direction can be imaged. When longer integration periods are used, the light reflected off the print media is collected while the print media is moving and the motion of the print media means the printed content is blurred in the direction of motion. The blurring in the direction of motion has the effect of averaging the pixel data in one direction, the in-track (feed) direction. Averaging the pixel data through blurring is also known as optical averaging. By performing the averaging optically with longer integration periods, the amount of data that is transferred to and processed by a processing device (e.g., 708 in FIG. 7) is reduced. Blurring reduces image resolution in the in-track direction, and is therefore generally avoided for applications that require the identification of artifacts that are small and occur randomly.

The transparent cover 802 is disposed over an opening 801 in the housing 810. Transparent cover 802 is optional and can be omitted in other embodiments in accordance with the invention.

Integrated imaging system 702 can also include vent openings 818, 820. Vent opening 818 can be used to input air or gas while vent opening 820 can be used to output exhaust. The input air or gas can be used to maintain a clean environment and control the temperature within integrated imaging system 702. In another embodiment in accordance with the invention, integrated imaging system 702 can include one or more vent openings (e.g., vent opening 818) that input air or gas and the opening 801 in the housing 810 is used to output exhaust.

FIG. 9 is a cross-sectional view along line 9-9 in FIG. 7 in an embodiment in accordance with the invention. As described, light source 800 transmits light through transparent cover 802 and towards the surface of the print media (not shown). The light reflects off the surface of the print media, propagates along folded optical assembly, and is directed toward lens 816. Lens 816 focuses the light to form an image on image sensor 806. Image sensor 806 can be implemented with any type of image sensor, including, but not limited to, one or more linear image sensors constructed as a charge-coupled device (CCD) image sensor or a complementary metal oxide semiconductor (CMOS) image sensor.

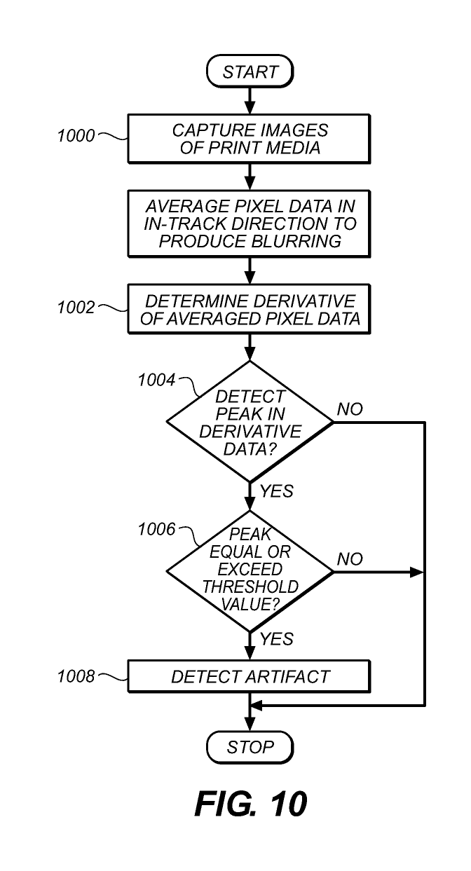

The image of the print media formed on the image sensor 806 is converted to a digital representation, or image, of the media suitable to analysis in a computer or processing device. Referring now to FIG. 10, there is shown a flowchart of a method for detecting artifacts in printed content on a moving print media in an embodiment in accordance with the invention. The method is described in conjunction with one artifact, but those skilled in the art will recognize the method can be used to detect multiple artifacts.

Initially, one or more images of the content printed on the moving print media are captured by an imaging system (block 1000). The imaging system is implemented as an integrated imaging system shown in FIGS. 7-9 in an embodiment in accordance with the invention.

The pixel data is then averaged in one direction, the in-track direction, to produce blurring in the image or images (block 1002). The pixel data is averaged optically through the use of a longer integration time in one embodiment in accordance with the invention. The amount of optical averaging can be increased by reducing the frequency of the pulses from the motion encoder (e.g., 710 in FIG. 7) and extending the integration time of the image sensor (e.g., 806 in FIG. 8) in the imaging system (e.g., 702 in FIG. 8). Reducing the frequency of the pulses has the benefit of reducing the amount of data transferred to the image processing device and of reducing the numerical averaging performed by the image processing device (e.g., 708 in FIG. 7). Additional numerical averaging or other image processing of the pixel data in the in-track direction can be computed by the processing device on images captured by the image sensor. The amount of optical image averaging can be decreased with an increase in the numerical averaging required. The ability to using optical averaging not only significantly reduces the camera hardware cost, but also its footprint size, and all without sacrificing the ability to detect inkjet printing related artifacts.

In another embodiment in accordance with the invention, averaging of the pixel data in one direction can be performed by a processing device (e.g., 708 in FIG. 7) using multiple images captured by the image sensor. The images can be captured with shorter integration times in an embodiment in accordance with the invention. The processing device numerically averages the pixel data in one direction, the in-track direction, to produce blurring in an image or images. The processing device can also perform other types imaging processing procedures in addition to the numerical averaging of the pixel data.

A derivative of the averaged pixel data is then determined, as shown in block 1004. Artifacts produce high and low peaks in the derivative data, as shown in FIG. 11. For example, the average of the pixel data for the blank streak depicted in FIG. 5 produces an upward peak 1100 in the plot of the averaged pixel data and an upward peak 1102 followed by a downward peak 1104 in the plot of the derivative data. For the darker streak shown in FIG. 6, the average of the pixel data produces a downward peak 1106 in the plot of the averaged pixel data and a downward peak 1108 followed by an upward peak 1110 in the plot of the derivative data. When the streams of ink drops are uniform and evenly spaced, as shown in FIG. 4, there are no peaks in the plots of the average of the pixel data or in the derivative data.

A determination is then made at block 1006 as to whether or not one or more peaks are detected in the derivative data. If a peak or peaks is detected, a determination is made at block 1008 as to whether or not the value of the peak is equal to or exceeds a threshold value. If the value of the peak is equal to or greater than the threshold value, an extended image artifact produced in the in-track direction is detected (block 1010). The shape and direction of the peaks in the derivative data can be used to identify the type of artifact and assist in the correction of the event that is producing the artifact.

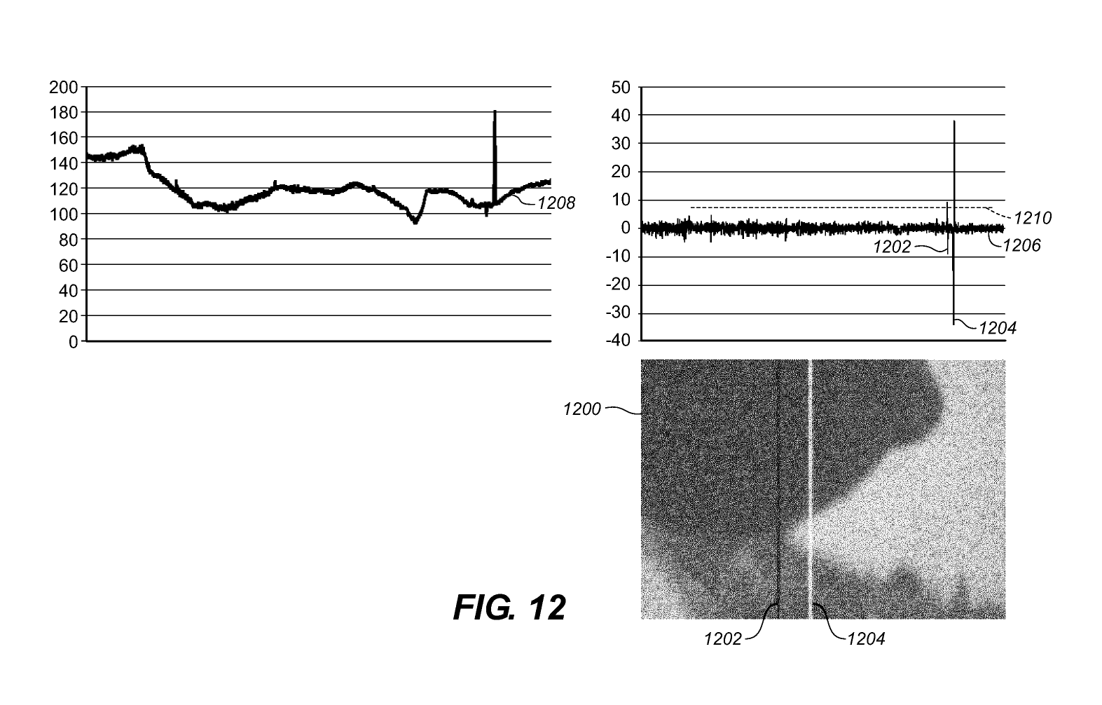

FIG. 12 illustrates a portion of printed content that includes two artifacts and examples of average and derivative data in an embodiment in accordance with the invention. The portion of the printed content is a portion of an image in the illustrated embodiment. Content 1200 includes a darker streak 1202, possibly produced by a stuck on jet, and a blank streak 1204 possibly produced by a nozzle that has stopped ejecting ink drops. A plot 1206 of the derivative data for the entire image illustrates the peaks associated with the two artifacts. As described earlier, the darker streak 1202 and the blank streak 1204 produce higher and lower peaks in the derivative data. The higher peaks in the derivative data exceed a threshold value illustrated by line 1210. The artifacts of the darker and blank streaks are detected by analyzing the derivative data, determining presence of the higher and lower peaks, and determining whether either one peak (higher or lower peak) equals or exceeds a threshold value, or whether both peaks for each artifact equal or exceed threshold values.

The invention has been described in detail with particular reference to certain preferred embodiments thereof, but it will be understood that variations and modifications can be effected within the spirit and scope of the invention. And even though specific embodiments of the invention have been described herein, it should be noted that the application is not limited to these embodiments. In particular, any features described with respect to one embodiment may also be used in other embodiments, where compatible. And the features of the different embodiments may be exchanged, where compatible.

1. An integrated imaging system for a printing system that prints images on a moving print media can include a housing; an opening in the housing for receiving light reflected from the moving print media; a folded optical assembly in the housing that receives the reflected light and transmits the light a predetermined distance; and an image sensor within the housing that receives the light and captures one or more images of a printed image.
2. The integrated imaging system in clause 1 can further include a light source for emitting light towards the print media.
3. The integrated imaging system in clause 1 or clause 2 can further include a transparent cover over the opening in the housing.
4. The integrated imaging system as in any one of clauses 1-3, where the folded optical assembly includes a lens; and at least one mirror for directing the reflected light to the lens.
5. The integrated imaging system in any one of clauses 1-4 can further include at least two vent openings in the housing, one vent opening for inputting tempered air and one vent opening for outputting exhaust.
6. The integrated imaging system in any one of clauses 1-4 can further include a vent opening in the housing for receiving air or gas. The opening in the housing can be used to output exhaust.
7. An artifact detection system for a printing system can include a processing device; and an integrated imaging system. The integrated imaging system can include a housing an opening in the housing for receiving light reflected from a moving print media; a folded optical assembly in the housing that receives the reflected light and transmits the light a predetermined distance; and an image sensor within the housing that receives the light and captures one or more images of a printed image, wherein pixel data in the one or more images is transmitted to the processing device. The pixel data can be transmitted from the integrated imaging system to the processing device through a wired or wireless connection.
8. The artifact detection system in clause 7 can further include a light source for emitting light towards the print media.
9. The artifact detection system in clause 7 or clause 8 can further include a roller for transporting the print media through the printing system.
10. The artifact detection system in clause 9 can further include a motion encoder connected to the roller, where the motion encoder is adapted to output a signal that is proportional to a fixed amount of incremental motion of the print media.
11. The artifact detection system as in clause 9 or clause 10, where the integrated imaging system is disposed over the print media at a location where the print media is transported over the roller.
12. The artifact detection system as in any one of clauses 7-11, where the processing device is adapted to average the pixel data to produce blur in one direction.
13. The artifact detection system in any one of clauses 7-12 can further include at least two vent openings in the housing, one vent opening for inputting air or gas and one vent opening for outputting exhaust.
14. The artifact detection system in any one of clauses 7-12 can further include a vent opening in the housing for receiving air or gas. The opening in the housing can be used to output exhaust.
15. An artifact detection system in a printing system can include means for capturing one or more images of the content as the print media is moving to obtain pixel data; means for averaging the pixel data to produce blur in one direction; means for determining derivative data of the averaged pixel data; and means for determining whether one or more peaks are present in the derivative data.
16. The artifact detection system as in clause 15, where the means averaging the pixel data to produce blur in one direction comprises means for optically averaging the pixel data to produce blur in one direction.
17. The artifact detection system as in clause 15, where the means for averaging the pixel data to produce blur in one direction comprises means for numerically averaging the pixel data to produce blur in one direction.
18. The artifact detection system in any one of clauses 15-17 can further include means for determining whether one or more peaks detected in the derivative data equal or exceed a threshold value.
19. A method for detecting artifacts in content printed on a moving print media can include capturing one or more images of the content as the print media is moving to obtain pixel data; averaging the pixel data to produce blur in one direction; determining derivative data of the averaged pixel data; and determining whether one or more peaks are present in the derivative data.
20. The method as in clause 19, where averaging the pixel data to produce blur in one direction comprises optical averaging.
21. The method as in clause 19, where averaging the pixel data to produce blur in one direction comprises numerical averaging.
22. The method in any one of clauses 19-21 can further include determining whether one or more peaks detected in the derivative data equal or exceed a threshold value.

### PARTS LIST

100 printing system
102 printing module
104 printing module
106 linehead
108 dryer
110 quality control sensor
112 print media
114 transport direction
116 turnover module
200 printhead
202 nozzle array
204 support structure
206 heat
300 overlap region
500 blank streak
600 darker streak
700 printing system
702 integrated imaging system
704 print media
706 roller
708 image processing device
710 motion encoder
800 light source
801 opening in housing
802 transparent cover
804 folded optical assembly
806 image sensor
810 housing
812 mirror
814 mirror
816 lens
818 vent
820 vent
1100 peak
1102 peak
1104 peak
1106 peak
1108 peak
1110 peak
1200 portion of an image
1202 darker streak
1204 blank streak
1206 plot of derivative data
1208 plot of average of pixel data for entire image
1210 threshold value

1. An integrated imaging system for a printing system that prints images on a moving print media, the imaging system comprising:
a housing;
an opening in the housing for receiving light reflected from the moving print media;
a folded optical assembly in the housing that receives the reflected light and transmits the light a predetermined distance; and
an image sensor within the housing that receives the light and captures one or more images of a printed image.

2. The integrated imaging system as in claim 1, further comprising at least two vent openings in the housing, one vent opening for inputting tempered air and one vent opening for outputting exhaust.

3. The integrated imaging system as in claim 1, further comprising a light source for emitting light towards the print media.

4. The integrated imaging system as in claim 1, wherein the folded optical assembly comprises:
a lens; and
at least one mirror for directing the reflected light to the lens.

5. The integrated imaging system as in claim 1, further comprising a transparent cover over the opening in the housing.

6. The integrated imaging system as in claim 1, further comprising a vent opening in the housing for receiving air or gas.

7. The integrated imaging system as in claim 6, wherein the opening in the housing is used to output exhaust.

8. An artifact detection system for a printing system comprising:
a processing device; and
an integrated imaging system comprising:
a housing;
an opening in the housing for receiving light reflected from a moving print media;
a folded optical assembly in the housing that receives the reflected light and transmits the light a predetermined distance; and
an image sensor within the housing that receives the light and captures one or more images of a printed image, wherein pixel data in the one or more images is transmitted to the processing device.

9. The artifact detection system as in claim 8, further comprising at least two vent openings in the housing, one vent opening for inputting air or gas and one vent opening for outputting exhaust.

10. The artifact detection system as in claim 8, further comprising a light source for emitting light towards the print media.

11. The artifact detection system as in claim 8, further comprising a roller for transporting the print media through the printing system.

12. The artifact detection system of claim 11, further comprising a motion encoder connected to the roller, wherein the motion encoder is adapted to output a signal proportional to a fixed amount of incremental motion of the print media.

13. The artifact detection system as in claim 11, wherein the integrated imaging system is disposed over the print media at a location where the print media is transported over the roller.

14. The artifact detection system of claim 8, wherein the processing device is adapted to average the pixel data to produce blur in one direction.

15. The artifact detection system as in claim 8, further comprising a vent opening in the housing for receiving air or gas.

16. The artifact detection system as in claim 15, wherein the opening in the housing is used to output exhaust.

17. An artifact detection system in a printing system, comprising:
means for capturing one or more images of the content as the print media is moving to obtain pixel data;
means for averaging the pixel data to produce blur in a direction the print media is moving;
means for determining derivative data of the averaged pixel data; and
means for determining whether one or more peaks are present in the derivative data.

18. The artifact detection system as in claim 15, wherein the means averaging the pixel data to produce blur in one direction comprises means for optically averaging the pixel data to produce blur in one direction.

19. The artifact detection system as in claim 15, wherein the means for averaging the pixel data to produce blur in one direction comprises means for numerically averaging the pixel data to produce blur in one direction.

20. The artifact detection system as in claim 15, further comprising means for determining whether one or more peaks detected in the derivative data equal or exceed a threshold value.
